(19) United States
(12) Patent Application Publication
(10) Pub. No.: US 2005/0143145 A1
(43) Pub. Date: Jun. 30, 2005

(54) Communication method, communication terminal, and communication system

(76) Inventor: Itaru Maekawa, Karuizawa (JP)

Correspondence Address: KATTEN MUCHIN ZAVIS ROSENMAN, 575 MADISON AVENUE, NEW YORK, NY, 10022-2585, US

(21) Appl. No.: 10/991,336

(22) Filed: Nov. 17, 2004

(30) Foreign Application Priority Data
Nov. 19, 2003 (JP) 2003-390009

(51) Int. Cl. H04B 1/38

(52) U.S. Cl. 455/574; 455/343.4

(57) ABSTRACT

A communication terminal and a method of the present invention aim to save electric power in a wireless ad hoc network. According to the communication method, the signal transmission processing of stations is stopped in response to a beacon signal for sleep, which is sent from one of the stations. The signal transmission processing of the stations is carried out in response to a beacon signal for awakening. Since an operation mode of the stations is controlled by the beacon signal, it is possible to certainly transmit a signal, and secure a sleep state for saving electric power.

### BACKGROUND OF THE INVENTION

1. Field of the Invention

The present invention relates to a technology for carrying out communication among a plurality of communication terminals, and in particular relates to a technology for reducing electric power consumption in the communication among the plurality of communication terminals.

2. Description of the Related Art

In recent years, it has been common to carry about an information terminal due to the miniaturization and weight reduction of such an information terminal. In accordance with this, research on the construction of a wireless ad hoc network as an on-demand network is aggressively conducted. The ad hoc network does not need a base station and an access point, so that it is possible to easily construct the network even in a place without such an infrastructure. Using the ad hoc network, for example, a plurality of users can enjoy a game together through wireless communication with one another by use of portable game machines brought by each user.

In the ad hoc network, the terminals communicate with one another by use of technology such as IEEE802.11 and Bluetooth. There is no problem in the case where the terminal can always receive electric power supply from an external power source. In the case of the portable terminal which is driven by limited electric power of a battery, it is preferable that the consumption of the battery is reduced as less as possible. Thus, also in a communication standard such as the IEEE802.11, electric power regulation processing in an electric power saving mode is standardized.

FIG. 1 is a timing chart showing the operation of stations in the electric power saving mode, which is standardized in the 802.11. First, one of stations A to D sends out a beacon signal. The beacon signal, which is an annunciation signal, is sent to every station. A time window, which is called an announcement traffic indication message (ATIM) window, is started following the transmission of the beacon. This window indicates time in which a node has to maintain an active state. In the electric power saving mode standardized in the 802.11, each station sends out an ATIM signal during the ATIM window in order to prevent another station from sleeping.

Taking an example of FIG. 1, the station B sends an ATIM signal to the station C via unicast, and the station C sends an ACK signal back to the station B. The station A and the station D do not send or receive any ATIM signal, so that the station A and the station D can enter a sleep state after the end of the ATIM window. The station B and the station C, on the other hand, cannot enter the sleep state. After the end of the ATIM window, the station B sends data to the station C. The station C sends another ACK signal back to the station B after receiving the data. Before this beacon interval is ended, the station A and the station D are activated to send or receive a beacon signal. In the next ATIM window, since any station does not send or receive an ATIM signal, every station enters the sleep state after the end of the ATIM window.

In the timing chart shown in FIG. 1, a simple case is taken as an example to explain the electric power saving mode standardized in the 802.11. When the plurality of portable game machines structure the network, however, it is necessary to communicate status information of each game machine with one another, and hence much more signals are communicated. In a game application that highly demands real-time communication, it is necessary to frequently update the status information, and it is preferable that data is sent via multicast communication.

In carrying out the multicast communication, there is a problem in the electric power saving mode standardized by the 802.11 that an ATIM window is set even if an ACK signal is not sent back. In the standard electric power saving mode, an ATIM signal from another station is monitored during the ATIM window to determine a station to be slept. In other words, every station is in the active state during this period, though the station does not send or receive the status information. In a game application requiring little delay such as, for example, a racing game, a player often operates a virtual car while keeping pressing a direction key. At that time, it is necessary to always send its status information to another portable game machine, but the status information cannot be sent during the ATIM window.

### SUMMARY OF THE INVENTION

In view of the circumstances described above, the present inventor found out that saving electric power under a course of control, in which, as a general rule, data communication is carried out at least once within a predetermined time period, is more efficient than monitoring using the ATIM window.

To solve the foregoing problems, an object of the present invention is to provide a communication method for carrying out communication among a plurality of communication terminals, in which when or after one of the plurality of terminals sends out a first annunciation signal, the plurality of terminals enter a sleep state. According to this communication method, the communication terminal enters the sleep state upon sending or receiving the first annunciation signal, so that it is possible to realize electric power saving of the communication terminal.

In this communication method, the plurality of communication terminals in the sleep state are activated after a lapse of a predetermined time from a point in time when the first annunciation signal is sent or received. In an active state, when or after one of the plurality of communication terminals sends a second annunciation signal, the plurality of communication terminals may maintain the active state. According to this communication method, an operation mode of the communication terminal is controlled between the sleep state and the active state, in response to the transmission or receipt of the first annunciation signal and the second annunciation signal. Therefore, it is possible to certainly send or receive a signal, and stably secure a period for saving electric power by stopping the transmission or receipt of the signal.

According to another aspect of the present invention, in a communication method for carrying out communication in a wireless ad hoc network constructed by a plurality of communication terminals, the signal transmission or receipt processing of the plurality of communication terminals is stopped in response to a first annunciation signal sent from one of the plurality of communication terminals, and the signal transmission or receipt processing of the plurality of communication terminals is carried out in response to a second annunciation signal sent from one of the plurality of communication terminals.

According to further another aspect of the present invention, in a communication system which carries out communication among a plurality of communication terminals, the plurality of communication terminals enter a sleep state when or after one of the plurality of communication terminals sends a first annunciation signal.

Further another aspect of the present invention provides a communication terminal which enters a sleep state upon sending or receiving a first annunciation signal, and maintains an active state upon sending or receiving a second annunciation signal. Since the terminal enters the sleep state upon sending or receiving the first annunciation signal, it is possible to save electric power of the communication terminal. Since the communication terminal maintains the active state upon sending or receiving the second annunciation signal, it is possible to obtain a transmission or receipt period of a signal.

Further another aspect of the present invention provides a program which makes a computer perform a function of shifting the operation state of a wireless interface into a sleep state, in which only part of functions are available, upon sending or receiving a first annunciation signal, and a function of maintaining the operation state of the wireless interface in an active state, in which every function is available, upon sending or receiving a second annunciation signal.

It should be noted that applicable aspects of the present invention also include any combinations of the foregoing components, as well as ones in which the components and expressions of the present invention are replaced among methods, apparatuses, systems, recording media, computer programs, etc.

### BRIEF DESCRIPTION OF THE DRAWINGS

FIG. 1 is a timing chart showing the operation of stations in an electric power saving mode standardized by the 802.11;

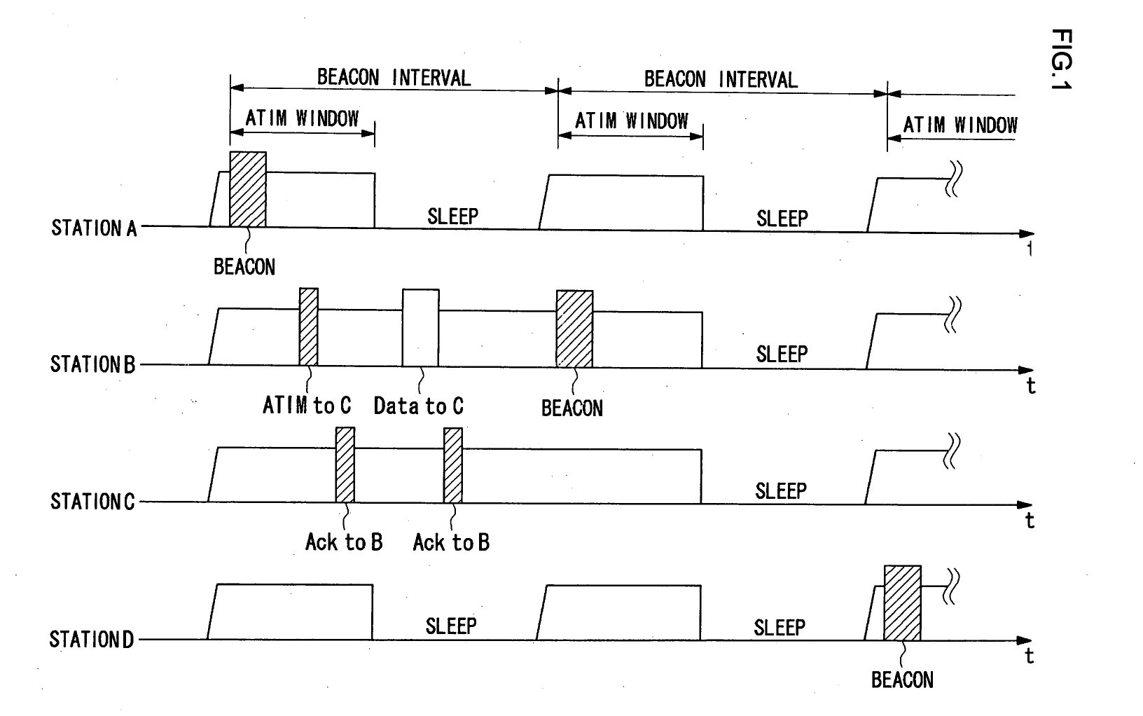

FIG. 2 is a diagram showing a communication system according to an embodiment;

FIG. 3A is a diagram showing a situation in which four stations carry out unicast communication with one another, and FIG. 3B is a diagram showing a situation in which one station is assigned as an access point, and the other three stations mutually carry out unicast communication with the access point;

FIG. 4 is a diagram showing a situation in which each station carries out multicast communication;

FIG. 5 is a timing chart showing the operation of the stations in an electric power saving mode according to the embodiment;

FIG. 6 is a functional block diagram of a game machine;

FIG. 7 is a timing chart showing the operation of the stations in an improved electric power saving mode according to a modified example of the embodiment; and

FIG. 8 is a timing chart showing the operation of the stations in an improved electric power saving mode according to further another modified example of the embodiment.

### DETAILED DESCRIPTION OF THE INVENTION

The following embodiment will offer technology for realizing electric power saving in communication among a plurality of terminals.

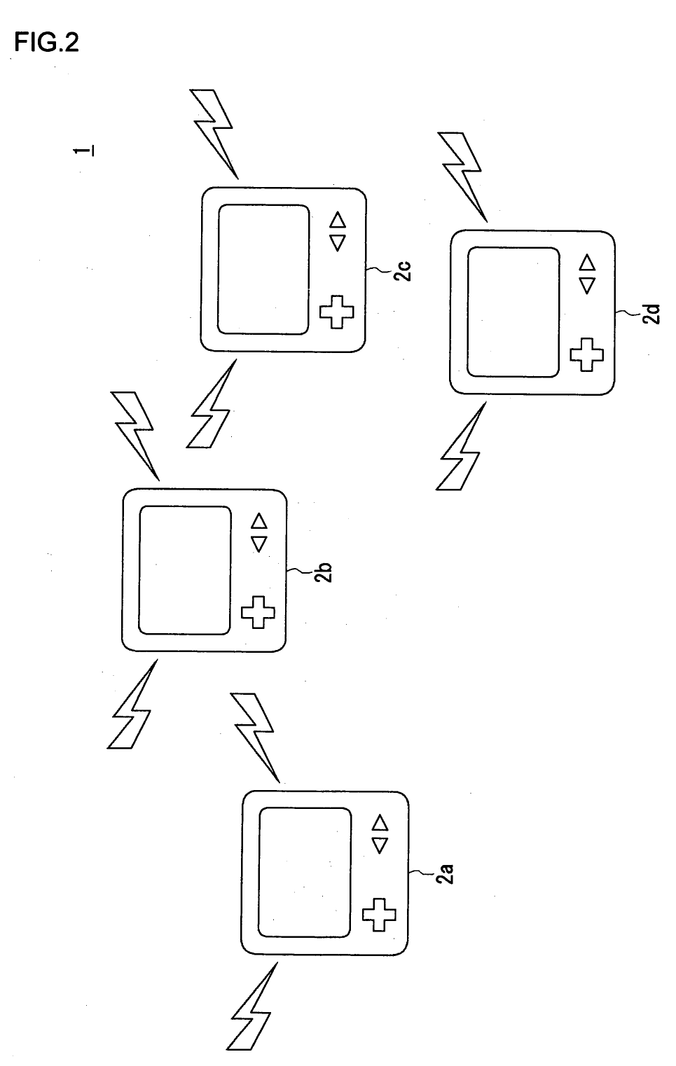

FIG. 2 shows a communication system 1 according to an embodiment of the present invention. This communication system 1 comprises a plurality of communication terminals, and four game machines 2a, 2b, 2c, and 2d are illustrated in FIG. 2 as the communication terminals. The number of the game machines 2 is not limited to four, and may be other than four. Each of the game machines 2 has a wireless communication function, and the plurality of game machines 2 are gathered to construct a wireless network. A wireless ad hoc network may be constructed by using a wireless LAN standard such as, for example, IEEE802.11b. MAC layer technology of the IEEE802.11b adopts CSMA/CA (Carrier Sense Multiple Access with Collision Avoidance) as an access control method, and each terminal has the function of sending data after having confirmed that a communication path keeps opening for a predetermined time or more. This waiting time is the sum of a minimum waiting time and a random waiting time different from terminal to terminal. The waiting time prevents a situation in which the plurality of terminals send data all at once after a predetermined time from previous communication and signals collide with one another. In unicast communication, whether or not data is normally sent is judged whether or not an ACK (acknowledge) signal from a receiver arrives. If the ACK signal does not arrive, the data is resent on the assumption that there would be communication failure.

Since the communication system 1 constructs the ad hoc network, it is possible to realize communication among the plurality of game machines 2 without any additional infrastructure such as a base station and an access point. Each of the game machines 2 receives status information of the other game machines, so that a plurality of players can enjoy the same game application at the same time.

Categorizing game applications from the viewpoint of “real time” properties, the game applications are mainly divided into two groups, that is, a game much requiring real-time communication and a game less requiring the real-time communication. The game much requiring the real-time communication such as, for example, a fighting game and a racing game, makes rapid progress, so that the input operation of a user has to be immediately reflected in output such as a game screen. The game less requiring the real-time communication such as a match game including chess and mahjongg and RPG (role playing game), on the other hand, makes relatively slow progress.

The game screen is updated at a predetermined frame rate or a refresh rate. The renewal speed of a single field is approximately 16.7 milliseconds (1/60 second) at present. Thus, in the game application much requiring the real-time communication, that is, requiring short delay, it is preferable that the own status information be let the other game machines know and the status information of the other game machines be let the own game machine know at least once within the single field (16.7 milliseconds). Taking the case of the racing game, for example, the status information is essential information including a position on a course, the direction and speed of a car and the like. The status information is the essential information in this embodiment, because the reliability of communication in wireless environment is not high. If sufficient reliability is ensured, it is preferable to send difference information between past and present. In the communication system 1, each of the game machines 2 independently and asynchronously carries out the application. The game application not requiring the short delay can perform resend processing even if the data cannot be updated on a field basis, so that there is less possibility that the processing of the application is greatly affected.

Three types of communication methods for realizing the communication system 1 by direct communication among the game machines will be hereinafter described. An IEEE802.11 protocol is used as a communication standard. The IEEE802.11 protocol has the advantage of being easily connectable to the Internet, as compared with a protocol such as Bluetooth. Since the game machine 2 uses the IEEE802.11 as a communication protocol, the game machine 2 is connectable to another terminal through the Internet, in addition to the construction of the wireless network, so that the expandability of the communication system 1 is improved.

(Type 1)

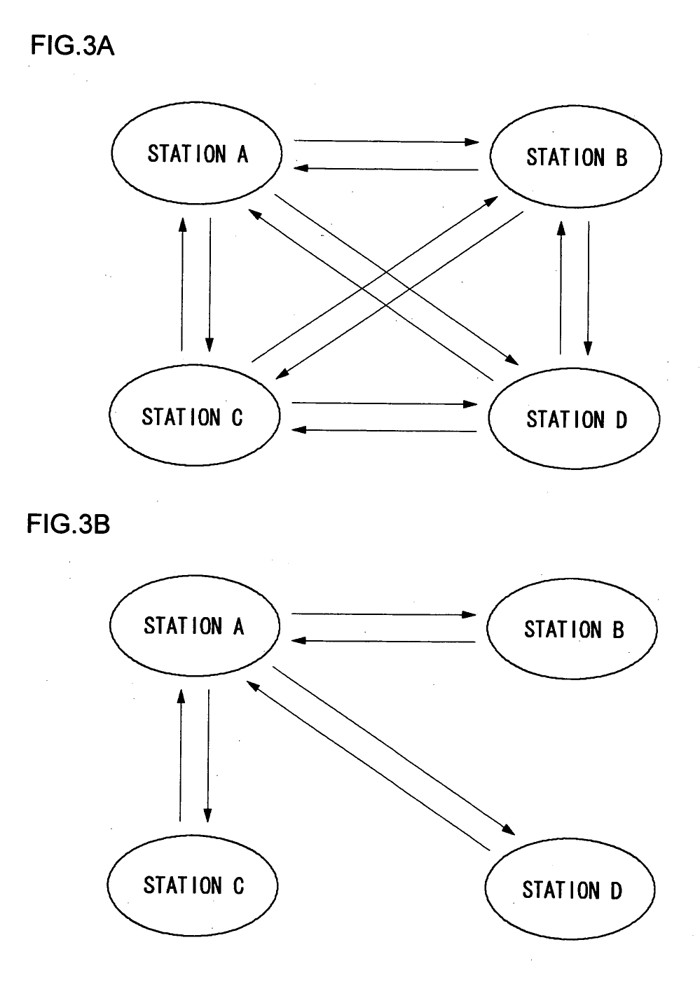

In a type 1, each station carries out the unicast communication, in which each station designates a single communication partner. FIG. 3A shows a situation in which the four stations mutually carry out the unicast communication. The stations correspond to the game machines 2 in the communication system 1. In the 802.11 protocol, each station sends out the status information to the other three stations. Thus, in the unicast communication, the status information is communicated for twelve times in total, and communication is carried out for twenty-four times in total with consideration of ACK signals sent back as receipt responses. In the application requiring the short delay, it is necessary to carry out the twenty-four-time communication within the single field. In the CSMA/CA, the communication is controlled in such a manner that packets do not collide. It is substantially difficult, however, to carry out the twenty-four-time communication at within 16.7 milliseconds while preventing the collision of packets. Increase in the number of stations further increases the number of communication necessary per field. According to the foregoing reason, the communication method of the type 1 shown in FIG. 3A is effective for the game application not requiring the short delay.

(Type 2)

In a type 2, one station functions as an access point, and the other stations carry out the unicast communication. FIG. 3B shows a situation in which a station A functions as the access point, and the other three stations mutually carry out the unicast communication with the station A. The station A receives status information from the other three stations B, C, and D. The station A brings together its own status information and the status information of the stations C and D into one packet, and sends it to the station B. In a like manner, the station A sends the station C the status information of the three stations except for the station C, and sends the station D the status information of the three stations except for the station D. Accordingly, in this unicast communication, the status information is communicated for six times in total, and communication is carried out for twelve times in total with consideration of ACK signals sent back as receipt responses. As compared with the communication method of the type 1 shown in FIG. 3A, a host CPU of the station A serving as the access point is under a heavy load. However, the number of communication is reduced, so that the communication method of the type 2 is more suitable for data communication requiring high speed than the type 1.

(Type 3)

In a type 3, each station carries out multicast communication. In the ad hoc network in the 802.11, a basic service set ID (BSSID) being a random value is set on each network, in order to distinguish the network from another one. Thus, each station can send its own data frame to the other stations, which compose a group within the same basic service area, via multicast by including the BSSID in the data frame. When a communication protocol other than the 802.11 is used, each station may carry out the multicast communication by designating addresses of the other three stations.

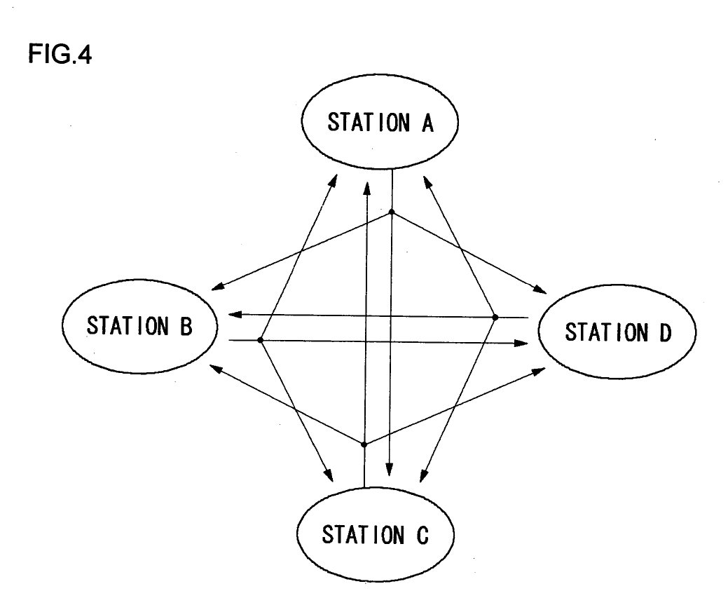

FIG. 4 shows a situation in which each station communicates the same data via multicast. Namely, a station A sends out its own status information by one packet including the BSSID in the data frame. Stations B, C, and D do the same thing. Thus, in this multicast communication, the status information is communicated for four times in total. An ACK signal is not sent back in the multicast communication. Therefore, as compared with the communication methods of the type 1 and the type 2 shown in FIGS. 3A and 3B, since the number of communication is significantly reduced, the communication method of the type 3 is suitable for data communication requiring high speed, and a load on each station does not become large. Therefore, the communication method of the type 3 shown in FIG. 4 is the most effective for the game application requiring short delay.

There are three types of communication methods in the communication system 1 according to this embodiment, as described above, but it is preferable to save electric power of the game machines 2 (stations) in any of the types. As in the case of a cellular phone or the like, realizing intermittent operation in a time base in a wireless ad hoc network terminal significantly contributes to the saving of the electric power. In the following description, a state in which only a part of a wireless interface operates or can operate with extremely low power consumption due to the interruption of electric current to a bias circuit of a transceiver section (mainly comprises an analog circuit) of the wireless interface, a pause of a clock in a modem section/MAC section and the like is called a sleep state. A state in which all functions of the wireless interface operate or can operate is called an active state. In this embodiment, the electric power is saved by using a beacon signal for sleep efficiently and extending a period of the sleep state. Considering the possibility of the electric power saving, the electric power saving is generally easy in the application not requiring short delay, because a long sleep state can be set therein while the communication between a plurality of stations is realized stably. Taking the case of a latently severe game application requiring high speed communication, a communication method for realizing the electric power saving even in such an environment will be hereinafter described.

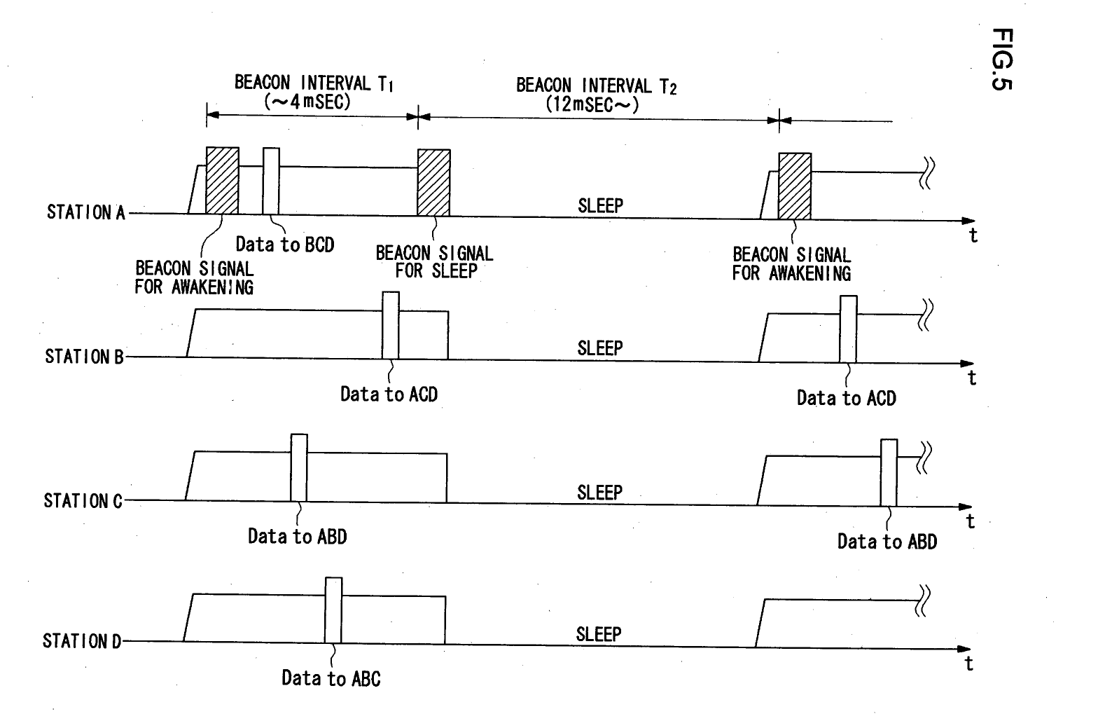

FIG. 5 is a timing chart showing the operation of stations in an electric power saving mode according to this embodiment. In this timing chart, a beacon signal serving as an annunciation signal is sent to every station. A beacon frame includes an indispensable field such as a time stamp, a beacon interval, capability information, a service set ID, and a support rate, and an option field such as an FH parameter set, a DS parameter set, a CF parameter set, an IBSS parameter set, and a TIM. Option information exists only when it is needed to be used. The station sends out the beacon signal after having waited for a random waiting time, which is called back-off, from a target beacon transmission time (TBTT) being the last time of the previous beacon interval.

When the station receives the beacon signal before its own transmission time, the transmission of a pending beacon signal is canceled. Therefore, in the communication system 1, only one station sends out the beacon signal. The beacon frame has to be processed by every station, so that every station starts up and is in the active state before the TBTT.

In an example shown in FIG. 5, a sender of the beacon signal is fixed, in other words, the station A is in charge of the transmission of a beacon signal. Accordingly, it is possible to prevent a situation in which a plurality of stations send out beacon signals at the same time and the beacon signals collide with each other. Communication shown in FIG. 5 adopts the multicast communication of the type 3, in view of prime importance on high speed in data communication. Therefore, each station does not need to monitor a response of an ACK signal, and it is possible to transmit the status information to the plurality of stations by one packet.

In this timing chart, the station A first sends out a beacon signal for awakening. The beacon signal for awakening declares every station to be in an awake state (active state). This declaration is carried out by use of an available field of the beacon frame, and, for example, the FH parameter set, the TIM, and the like serving as the option field are used. Every station has been activated in this timing. Upon receiving the beacon signal for awakening, the stations B, C, and D recognize that the transmission timing of their own status information has come. After sending or receiving the beacon signal for awakening, each of the stations A, B, C, and D generates a random back-off time with maintaining the active state, to determine the transmission time of its own status information. Then, each station sends out its own status information to the other stations via multicast at the corresponding determined transmission time. The timing chart of FIG. 5 shows a situation in which each station sends out data via multicast at random timing. The CSMA/CA also performs collision prevention control, so that when another station carries out data transmission at its own transmission time, its own status information of the relevant station is sent after the completion of the data transmission by another station. Every station completes transmission of data before the next beacon signal for sleep is sent out (during a beacon interval T₁).

Then, the station A sends out the beacon signal for sleep. The beacon signal for sleep declares every station to shift into the sleep state. As in the case of the beacon signal for awakening, this declaration of the beacon signal for sleep is carried out by use of an available field of the beacon frame, and, for example, the FH parameter set, the TIM, and the like serving as the option field are used. Every station has been activated in this timing. Upon receiving the beacon signal for sleep, the stations B, C, and D recognize to shift into the sleep state, and enter an electric power saving state (sleep state) by controlling a bias circuit and a clock circuit. The station A enters the sleep state after sending out the beacon signal for sleep.

Every station in the sleep state is made into the active state after a lapse of a predetermined time from a point in time when the beacon signal for sleep is sent or received, that is, after a lapse of a beacon interval T₂, to send or receive the next beacon signal. This transition from the sleep state to the active state is autonomously carried out by using a timer and the like inside the wireless interface terminal. The startup timing of each station is determined by relation depending on a device, such as time for making an internal analog circuit stable. The later the startup timing of each station, the more electric power is saved. When the station A sends out a beacon signal for awakening in this situation, every station determines time for transmitting its own status information while maintaining the active state, and sends out its own status information at that time.

As shown in the timing chart of FIG. 5, an active period and a sleep period of the station are compulsorily set in this embodiment by using two types of beacon signals. To be more specific, a predetermined time is divided into two time periods, and each station is controlled so as to send or receive data in one time period and enter the sleep state in the other time period. Therefore, an unnecessary active period is reduced as much as possible, and the station sleeps for the rest of time, so that it is possible to realize electric power saving with high efficiency.

In consideration of a field cycle (16.7 milliseconds), it is preferable that a transmission cycle of the beacon signal for awakening, that is, (T₁+T₂) be set to 16.7 milliseconds or less, for example, 16 milliseconds, which is shorter than 16.7 milliseconds. Since an activation cycle of the station is set shorter than 16.7 milliseconds, it is possible to send or receive the status information at least once within each single field. Accordingly, it is possible to smoothly advance a game of the game application requiring short delay while certainly ensuring the sleep period.

When (T₁+T₂) is set to a predetermined time, the beacon interval T₁ may be determined in accordance with, for example, the number of the game machines 2 joining the network or the like. The beacon interval T₁ is extended when the number is high, and the beacon interval T₁ is shortened when the number is low. It is expected that data transmission time of each station is approximately a few hundred μ seconds, though it depends on the game application and the like. Thus, a beacon interval T₁ of approximately 4 milliseconds is sufficient. When the beacon interval T₁ is set at 4 milliseconds and the beacon interval T₂ is set at 12 milliseconds, the sleep period of the station is set at 75% of the whole. The beacon interval T₁ may be set in consideration of a data modulation mode, game data size, and the like. Increasing a value of T₂/(T₁+T₂) can increase the efficiency of electric power saving, and hence it is preferable to set the beacon interval T₁ as short as possible.

The station A, which is in charge of the transmission of a beacon signal, can determine the beacon interval T₁ in consideration of the foregoing situation. The beacon interval T₁ may be dynamically varied, and the beacon interval T₂ may also be dynamically varied in accordance with the dynamically varied beacon interval T₁. It is preferable that the station A appropriately varies the beacon interval T₁ in response to a external factor when, for example, the number of the game machines 2 increases or decreases, when communication environment is changed, or the like. When (T₁+T₂) is set to the predetermined time, a value of T₂ is determined in accordance with variation of T₁. When a condition of “(T₁+T₂)≦predetermined time” exists, a value of T₂ is determined in accordance with variation of T₁ within the range of this condition. Thus, it is possible to carry out electric power saving suitably for a situation. Values of the beacon intervals set by the station A are installed in the beacon frame. Accordingly, the stations B, C, and D can know the transmission timing of the next beacon, and therefore, can shift from the sleep state into the active state concurrently with the timing.

Assuming the case of requiring short delay, the foregoing description is on the prerequisite that the status information is updated at least once within a single field (16.7 milliseconds). When such latency is not required, however, it is possible to set a long time of the beacon interval T₂ with respect to the beacon interval T₁. In this case, since the sleep period is further extended, it is possible to realize electric power saving with higher efficiency. The status information may be updated, for example, at least once in two fields (33.3 milliseconds) or at least once in three fields (50 m second) by a request from the game application.

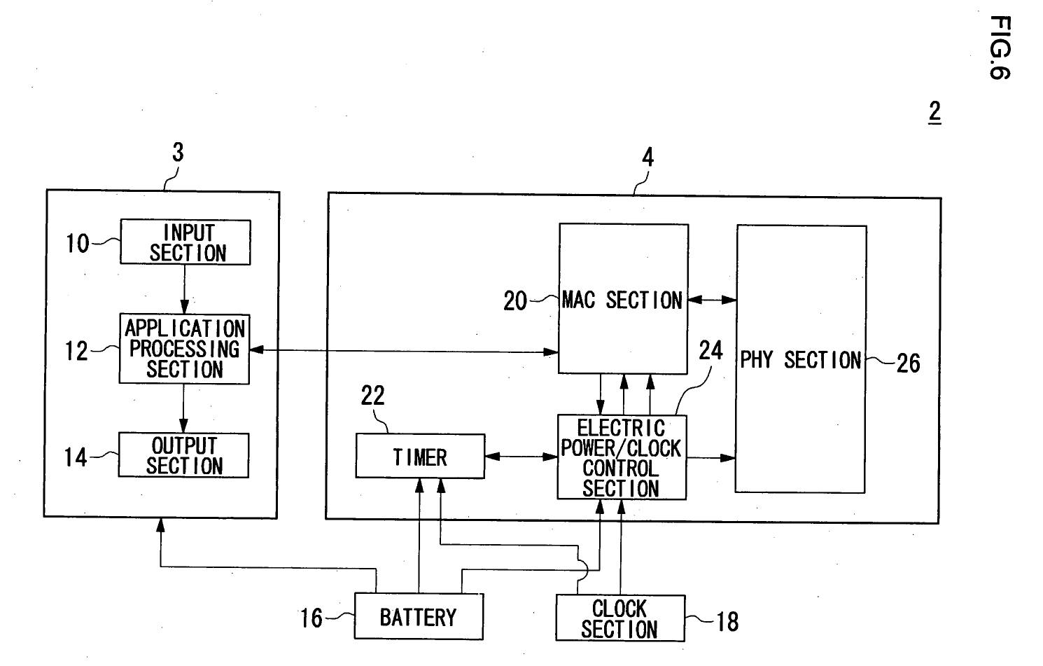

FIG. 6 is a functional block diagram of the game machine 2. The game machine 2 comprises a game processing section 3 which performs operation related to game processing, and a communication processing section 4 which performs operation related to communication. The game machine 2 further comprises a battery 16 which supplies electric power, and a clock section 18 which generates a pulse at regular time intervals. The game processing section 3 has an input section 10, an application processing section 12, and an output section 14. The communication processing section 4 has a MAC section 20, a timer 22, an electric power/clock control section 24, and a PHY section 26.

A communication function according to this embodiment is realized in the communication processing section 4 by use of a CPU, a memory, a program loaded into the memory, and the like, and FIG. 6 shows functional blocks, which are composed of the cooperation of them. The program may be installed in the game machine 2, or may be provided from the outside in the form of a recording medium having stored the program. Therefore, one skilled in the art understands that these functional blocks are realized in various forms by only hardware, only software, or combinations thereof.

The input section 10 is an operation button group including a direction key which receives an operation command from a user and the like. The application processing section 12 carries out game application on the basis of the operation command input from the input section 10 and the status information of the other game machines 2 received by the PHY section 26. The output section 14 comprising a display, a speaker, and the like outputs a result of processing in the application processing section 12. Its own status information processed in the application processing section 12 is stored in a buffer of the MAC section 20. The clock section 18 supplies a clock to the timer 22 and the electric power/clock control section 24. The timer 22 is shown as an independent section in FIG. 6. The timer 22, however, may be installed as one function of the MAC section 20, or as one function of the electric power/clock control section 24.

The battery 16 supplies electric power to the game processing section 3, the timer 22, and the electric power/clock control section 24. The electric power/clock control section 24 controls the electric power and clock supplied to the MAC section 20 and the PHY section 26. To be more specific, the electric power/clock control section 24 can shift the MAC section 20 and the PHY section 26 from the active state into the sleep state, or from the sleep state into the active state. The MAC section 20 has the functions of generating a beacon signal, and of analyzing a beacon signal received from another game machine 2 through the PHY section 26.

When the game machine 2 is in charge of the transmission of a beacon signal, the MAC section 20 inserts the value of a beacon interval into the indispensable field of the beacon frame. At this time, the MAC section 20 adds information (a flag), which indicates that whether a beacon signal is for awaking or for sleep, to an available area of the option field in the frame. The PHY section 26 sends out the beacon signal at predetermined timing. The electric power/clock control section 24 controls the generation timing of the beacon signal by the MAC section 20, and the transmission timing of the beacon signal by the PHY section 26.

When the game machine 2 is not in charge of the transmission of a beacon signal, the MAC section 20 analyzes a received beacon signal to determine whether or not to enter the electric power saving mode. To be more specific, the MAC section 20 judges whether the received beacon signal is for awakening or for sleep based on the flag included in the option field. In the case of the beacon signal for sleep, the MAC section 20 sends a shift command into the electric power saving mode to the electric power/clock control section 24. The electric power/clock control section 24 stops clock supply to the MAC section 20 and the PHY section in order to stop electric power consumption in the MAC section 20 and the PHY section 26, and stops the operation of the MAC section 20 and the PHY section 26. Thus, the MAC section 20 and the PHY section 26 enter the sleep state. As described before, in the sleep state, a part of the communication processing section 4 operates or can operate with extremely low power consumption due to the interruption of electric current to a bias circuit of a transceiver section (mainly comprises an analog circuit) of the communication processing section 4, a pause of a clock in the electric power/clock control section 24 and the like.

At this time, the electric power/clock control section 24 sets the timer 22 so as to activate the MAC section 20 and the PHY section 26 after a lapse of a predetermined time from a point in time when the MAC section 20 and the PHY section 26 enter the sleep state. The timer 22 is controlled on the basis of a value of the beacon interval included in the beacon frame. The value of the beacon interval is sent from the MAC section 20 to the electric power/clock control section 24. It is preferable that a time from entrance to the sleep state till activation be set slightly shorter than the beacon interval T₂. The timer 22 counts a pulse supplied from the clock section 18, and supplies a wake signal to the electric power/clock control section 24 after a lapse of the predetermined time. Upon receiving the wake signal, the electric power/clock control section 24 shifts the MAC section 20 and the PHY section 26 into the active state. To be more specific, the electric power/clock control section 24 starts to supply clock to the MAC section 20 and the PHY section 26.

When the received signal is a beacon signal for awakening, the MAC section 20 and the PHY section 26 have already been activated. In other words, the MAC section 20 and the PHY section 26 have been activated by the foregoing timer control in order to receive the beacon signal for awakening. The game machine 2 maintains the active state until receiving the next beacon signal for sleep.

In addition, in a case that the received signal is a beacon signal for sleep, the MAC section 20 and the PHY section 26 have already been activated. In other words, the MAC section 20 and the PHY section 26 have been activated in order to receive the beacon signals for sleep and awakening. This operation of the MAC section 20 and the PHY section 26 is performed not only in this embodiment but in other embodiments.

When the PHY section 26 receives the beacon signal for awakening, the MAC section 20 determines the transmission time of the status information by using random numbers. The MAC section 20 reads the status information from the buffer and sends it at that transmission time. In a case that another signal exists at the transmission time, the MAC section 20 sends the status information with timing shifted, to prevent the status information from colliding.

When the game machine 2 is in charge of the transmission of a beacon signal, the MAC section 20 has recognized whether or not to enter the electric power saving mode by the timer control based on the value of the beacon interval included in the beacon frame. On the basis of this recognition, the MAC section 20 sends out a beacon signal for sleep or a beacon signal for awakening. In transmitting the beacon signal for sleep, the MAC section 20 sends a shift command into the electric power saving mode to the electric power/clock control section 24. The processing of the electric power/clock control section 24 is as described above. In transmitting the beacon signal for awakening, the MAC section 20 and the PHY section 26 have already been activated at a point in time of transmission. In other words, the MAC section 20 and the PHY section 26 have been activated by the timer control in order to send out the beacon signal for awakening. The game machine 2, which is in charge of the transmission of a beacon signal, maintains the active state until sending out the next beacon signal for sleep. Upon sending out the beacon signal for awakening, the MAC section 20 determines the transmission time of the status information by using random numbers. The MAC section 20 reads the status information from the buffer at that transmission time and sends it.

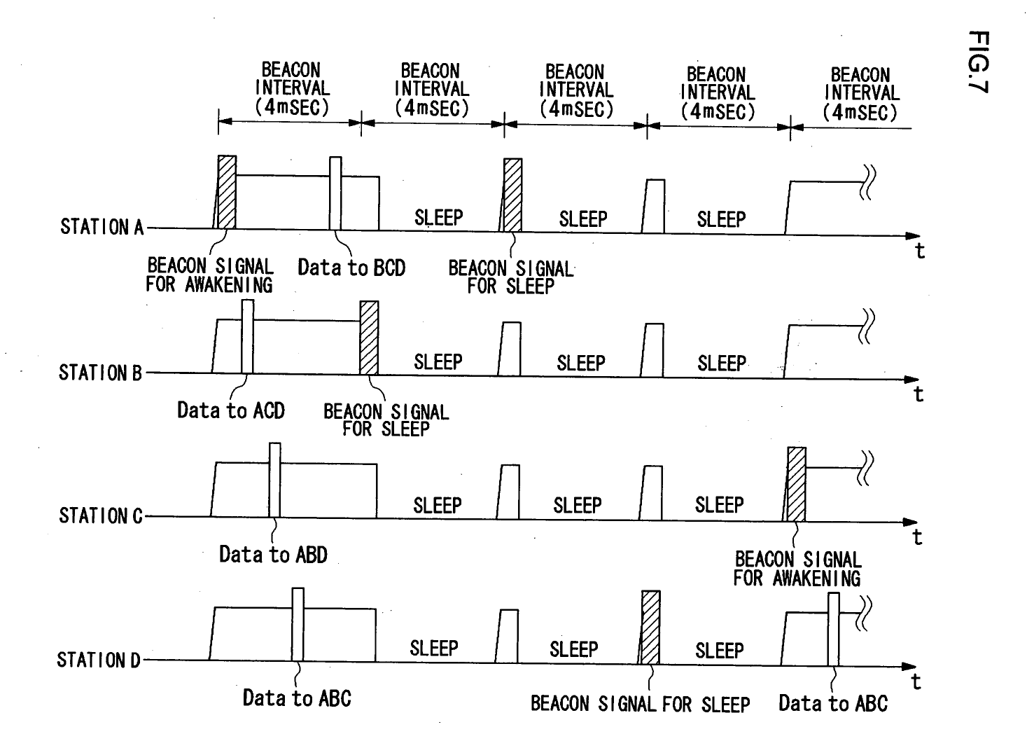

FIG. 7 is a timing chart showing the operation of the stations in an improved electric power saving mode according to a modified example of this embodiment. In this example, a sender of a beacon signal serving as an annunciation signal is not fixed, and the stations A to D try to send a beacon signal after having waited for a random back-off time. In the case where a beacon sender is fixed, if the beacon sender leaves the network, it is necessary to select another sender of a beacon signal after that. In the case where a beacon sender is not fixed, the station can easily join and leave the network in the communication system 1 without restraint. In this modified example, a beacon interval is fixed at, for example, 4 milliseconds. Operation of each station which receives or sends the beacon signal is the same as that of the station which receives or sends the beacon signal shown in FIG. 5. Any of the stations A to D sends out the beacon signal for sleep for three times after the beacon signal for awakening. It is set in every station how many times the beacon signal for sleep is sent between the beacon signals for awakening. The station sends out the beacon signal after having waited for a random waiting time from a target beacon transmission time TBTT, which corresponds to the last time of the previous beacon interval. When the station receives a beacon signal before its own transmission time, the transmission of a pending beacon signal is canceled. Every station counts the number of beacon signal which is sent by itself or other stations. Until the number of beacon signal for sleep reaches three, every station tries to send the beacon signal for sleep. Upon sending or receiving the beacon signal for sleep, each station enters the sleep state.

In the operation of the stations shown in FIG. 7, the stations have to start up every 4 milliseconds to send or receive the beacon signal for sleep, and hence the efficiency of electric power saving is slightly reduced as compared with the operation of the stations shown in FIG. 5. The operation of the stations shown in FIG. 7, however, has the advantages that the setup of a beacon interval can be simplified and installation is easy. Since every game machine 2 generates a beacon signal, there is the advantage of evenness in electric power consumption. It is possible to vary the beacon interval in accordance with the amount of data of the game application, the number of the game machines 2 joining the network and the like. In the timing chart of FIG. 7, the beacon interval is set at 4 milliseconds by dividing 16 milliseconds, which correspond to the cycle of the beacon signal for awakening, into quarters. The beacon interval, however, may be adjusted appropriately for electric power saving, in such a manner that, for example, the beacon interval may be set by dividing 16 milliseconds into three when the number of participants increases, or the beacon interval may be set by dividing 16 milliseconds into five when the number of participants decreases.

Using the functional block diagram of FIG. 6, difference between the operation of the stations shown in FIG. 5 and that shown in FIG. 7 will be described. In the example shown in FIG. 7, the MAC section 20 of every game machine 2 generates a beacon signal. Upon sending or receiving a beacon signal for awakening, the MAC section 20 generates a beacon signal for sleep for three times at the predetermined beacon intervals, and then, generates a beacon signal for awakening. The other processing is the same as that described on the operation of the stations shown in FIG. 5.

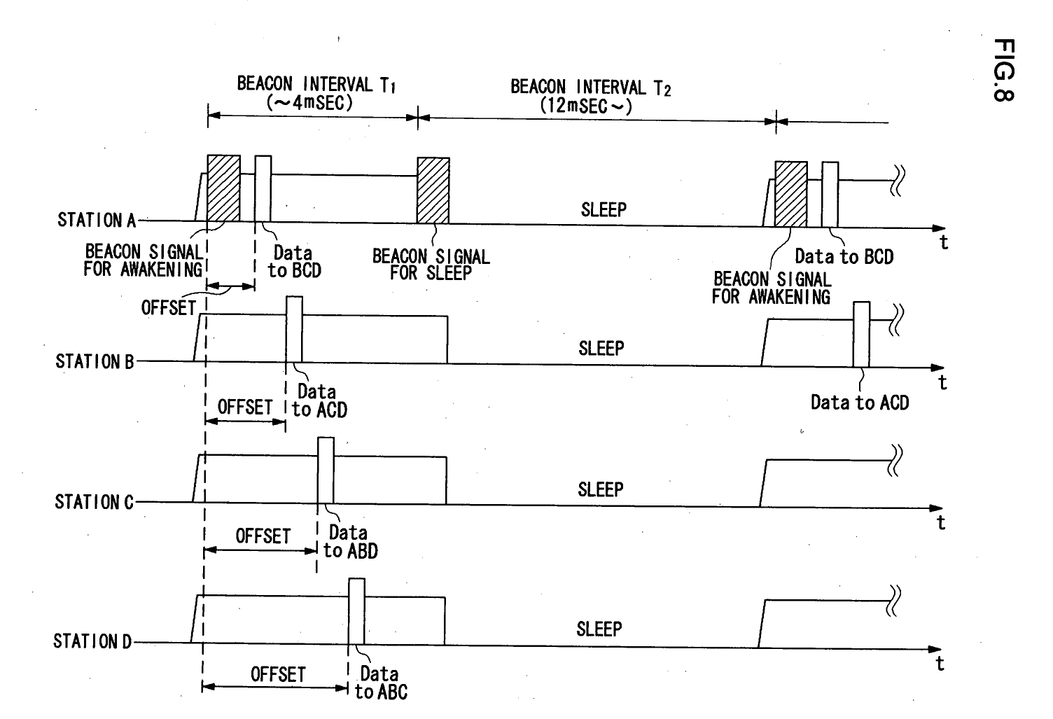

FIG. 8 is a timing chart showing the operation of the stations in an improved electric power saving mode according to further another modified example of this embodiment. In FIG. 8, a sender of a beacon signal serving as an annunciation signal is fixed to the station A, and a beacon interval is variable. The sender of the beacon signal, however, may not be fixed, or the beacon interval may be fixed. Operation from a beacon signal for sleep to a beacon signal for awakening is the same as that from the beacon signal for sleep to the beacon signal for awakening shown in FIG. 5.

In the modified example shown in FIG. 8, signal transmission by artificial time division multiple access (TDMA) is carried out from a beacon signal for awakening to a beacon signal for sleep. In other words, the transmission time of every station is staggered by an offset time, which varies from one station to another, with respect to the beacon signal for awakening. The offset time of every station may be staggered by 400 μ seconds, in such a manner that, for example, the offset time of the station A is set at 400 μ seconds, the offset time of the station B is set at 800 μ seconds, the offset time of the station C is set at 1200 μ seconds, and the offset time of the station D is set at 1600 μ seconds. The offset time may be fixedly assigned to each station, or may be dynamically assigned. When the station A always sends out the beacon signal as the illustrated example, it is easy to fixedly assign the offset time of each station. When which station sends out the beacon signal is not fixed, the station, which results in the sender of the beacon signal, may dynamically set the offset time. For example, assignment of the offset time, which is written in an available area of the option field of the beacon frame, is transmitted from the station sending out the beacon to each station. Upon receiving the beacon signal for awakening, each station recognizes its own offset time, and sends out its own status information after a lapse of the offset time. As described above, artificial TDMA communication can certainly prevent the collision of signals, and hence it is possible to carry out communication with high quality.

Up to this point, the present invention has been described in conjunction with the embodiments thereof. These embodiments are given solely by way of illustration. It will be understood by those skilled in the art that various modifications may be made to combinations of the foregoing components and processes, and all such modified examples are also intended to fall within the scope of the present invention. In the foregoing embodiment, the multicast communication of the type 3 is mainly adopted by a request of the short delay. The present invention, however, is effectively used not only for electric power saving control in requiring the short delay, but also in adopting the communication method of the type 1 or type 2.

1. A communication method for carrying out communication among a plurality of communication terminals, the method comprising allowing the plurality of terminals to enter a sleep state when or after one of the plurality of terminals sends out a first annunciation signal.

2. The communication method according to claim 1, wherein:
the plurality of communication terminals in the sleep state are activated after a lapse of a predetermined time from a point in time when the first annunciation signal is sent or received; and
in an active state, when one of the plurality of communication terminals sends a second annunciation signal, the plurality of communication terminals maintain the active state.

3. The communication method according to claim 2, wherein
each of the communication terminals maintains the active state until sending or receiving the next first annunciation signal, after each of the communication terminals sends or receives the second annunciation signal.

4. The communication method according to claim 2, wherein
each of the communication terminals sends its own information signal to the other communication terminals via multicast in the active state after sending or receiving the second annunciation signal.

5. The communication method according to claim 3, wherein
each of the communication terminals sends its own information signal to the other communication terminals via multicast in the active state after sending or receiving the second annunciation signal.

6. The communication method according to claim 2, wherein
each of the communication terminals sends its own information signal to the other communication terminals, after a lapse of a random time set by each communication terminal from a point in time when the second annunciation signal is sent or received.

7. The communication method according to claim 3, wherein
each of the communication terminals sends its own information signal to the other communication terminals, after a lapse of a random time set by each communication terminal from a point in time when the second annunciation signal is sent or received.

8. The communication method according to claim 4, wherein
each of the communication terminals sends its own information signal to the other communication terminals, after a lapse of a random time set by each communication terminal from a point in time when the second annunciation signal is sent or received.

9. The communication method according to claim 5, wherein
each of the communication terminals sends its own information signal to the other communication terminals, after a lapse of a random time set by each communication terminal from a point in time when the second annunciation signal is sent or received.

10. The communication method according to claim 2, wherein
each of the communication terminals sends its own information signal to the other communication terminals, after a lapse of an offset time assigned variably from one communication terminal to another from a point in time when the second annunciation signal is sent or received.

11. The communication method according to claim 1, wherein
the first annunciation signal is sent out from a predetermined communication terminal.

12. The communication method according to claim 1, wherein
the first annunciation signal is sent out from an arbitrary communication terminal after a lapse of a random time from predetermined time.

13. The communication method according to claim 1, wherein:
a second annunciation signal is transmitted at predetermined intervals; and
the transmission timing of the first annunciation signal can be dynamically set with respect to the transmission timing of the second annunciation signal.

14. The communication method according to claim 1, wherein
a second annunciation signal is transmitted at predetermined intervals, and
the first annunciation signal is transmitted at the same intervals as the second annunciation signal.

15. A communication method for carrying out communication in a wireless ad hoc network constructed by a plurality of communication terminals, the method comprising:
stopping the signal transmission or receipt processing of the plurality of communication terminals in response to a first annunciation signal sent from one of the plurality of communication terminals; and
carrying out the signal transmission or receipt processing of the plurality of communication terminals in response to a second annunciation signal sent from one of the plurality of communication terminals.

16. A communication system for carrying out communication among a plurality of communication terminals, the method comprising allowing the plurality of communication terminals to enter a sleep state when or after one of the plurality of communication terminals sends a first annunciation signal.

17. A communication terminal which enters a sleep state upon sending or receiving a first annunciation signal, and maintains an active state upon sending or receiving a second annunciation signal.

18. A program which makes a computer perform
a function of shifting the operation state of a wireless interface into a sleep state, in which only part of functions are available, upon sending or receiving a first annunciation signal, and
a function of maintaining the operation state of the wireless interface in an active state, in which every function is available, upon sending or receiving a second annunciation signal.
